(19) United States
(12) Patent Application Publication
(10) Pub. No.: US 2010/0239492 A1
(43) Pub. Date: Sep. 23, 2010

(54) Method and system for manufacturing carbon black

(76) Inventor: Jaswinder Singh Marzara, Mississauga (CA)

Correspondence Address: Brian R. Galvin, P.O. BOX 2360, SILVERDALE, WA, 98383-2360, US

(21) Appl. No.: 12/381,946

(22) Filed: Mar. 17, 2009

(51) Int. Cl. C01B 31/02; C08J 11/10; B01J 19/00

(52) U.S. Cl. 423/449.7; 422/150; 521/40.5

(57) ABSTRACT

A method of manufacturing carbon black comprising the steps of mixing waste tire material and waste plastic in a pressure vessel, charging the pressure vessel with an inert gas to a desired pressure control range, controllably heating the pressure vessel to increase temperature inside the vessel until the temperature reaches a desired temperature control range, while maintaining pressure within the pressure control range, and maintaining temperature and pressure within the respective control ranges for a desired soak time while venting gases generated in the pressure vessel, wherein substantially pure carbon black is produced, is disclosed.

### BACKGROUND OF THE INVENTION

1. Field of the Invention

The present invention relates generally to a process for the manufacture of carbon black using recycled materials.

2. Discussion of the State of the Art

Carbon black is an inorganic, synthetic black pigment made up of colloidal carbon material. It is in fact made up of approximately 87% to 97% pure elemental carbon by weight. Carbon blacks are manufactured under controlled conditions in general by the partial combustion and/or thermal cracking of natural gas, oil or another hydrocarbon. During the manufacture process primary carbon black particles fuse to form aggregates or aciniform particles. The shape and degree of aggregate branching is what gives carbon black its unique properties. The typical particle size ranges from 8 to 300 nanometers. The size of carbon black particles and aggregates will alter its functional characteristics to a degree. For example, finer particles increase reinforcement, abrasion resistance and improve tensile strength. Thus there are different grades of carbon black and a particular industry may desire a particular fineness level in the carbon black they utilize.

Carbon black is an important high tech commodity which is used in many industrial applications. Carbon black serves as a key ingredient for commercial use primarily in the rubber, paint and printing industries. The tire manufacture industry in particular is a major user of this commodity, consuming approximately 80% of total carbon black production. Carbon black serves as a filler that dissipates heat, provides increased strength and road adhesion and thus improves the durability and performance of automobile tires. Carbon blacks provide ultraviolet protection and are added to most marine, aeronautical, automotive and consumer paint products. When used in plastics carbon black provides increased strength and minimizes electrical conduction. Carbon black is also a key ingredient in the production of dry cell and lithium ion batteries. The primary pigment in “blacks” used for modern laser and ink jet cartridges is manufactured with carbon black. These and many other industrial uses worldwide currently consume over 18 billion (2006) pounds of this key commodity.

Currently the standard manufacturing process requires a unique plant designed specifically for the type of carbon black being manufactured. Carbon black is therefore typically made at one facility and then needs to be shipped to another for use. The carbon black industry, which has expanded along with automobile manufacturing, is typically energy-heavy. These manufacturing methods require the consumption of large volumes of petroleum products. This creates a very large energy footprint because of the fuels consumed and related carbon dioxide and heat emissions. The industry is currently faced with a need to address the problem of global warming as emissions of carbon dioxide are under much greater scrutiny as one of the gases in part responsible for the phenomenon.

It is an aim of the present invention to provide a method for reducing this energy footprint by using recycled products in the form of used tires and polyvinyl chloride (PVC) plastics waste as inputs thus reducing the need to use petroleum products or natural gas and vastly reducing carbon dioxide emissions. This invention specifically provides an energy efficient method of utilizing a renewable carbon product in a practical industrial application. This process creates a valid commercial use for waste tires and plastics and thus benefits the environment in this way as well. In an embodiment of the invention a tire manufacturing plant could have its own carbon black facility on premise to eliminate the expense and environmental costs associated with shipping the material from an offsite plant. Due to reduced input costs the invention will yield a much higher profit for the manufacturer over traditional methods.

### SUMMARY OF THE INVENTION

In order to provide a means of satisfying the aims described above, the inventors have conceived a novel method of producing carbon black using waste tires and waste plastic as raw materials. According to a preferred method of the invention, a method of manufacturing carbon black comprising the steps of mixing waste tire material and waste plastic in a pressure vessel, charging the pressure vessel with an inert gas to a desired pressure control range, controllably heating the pressure vessel to increase temperature inside the vessel until the temperature reaches a desired temperature control range, while maintaining pressure within the pressure control range, and maintaining temperature and pressure within the respective control ranges for a desired soak time while venting gases generated in the pressure vessel, wherein substantially pure carbon black is produced, is disclosed.

In another embodiment of the invention, a system for manufacturing carbon black comprising a pressure vessel adapted for receiving waste tire material and waste plastics, an inert gas charging system connected to the pressure vessel and capable of controllably applying pressure within the pressure vessel within a desired pressure control range, means for controllably heating the pressure vessel to increase the temperature until the temperature reaches a desired temperature control range, and means for venting gases generated by the reaction of the waste tire material and the waste plastics, wherein the waste tire material and waste plastics react to generate carbon black, is disclosed.

### BRIEF DESCRIPTION OF THE DRAWING FIGURES

FIG. 1 is a diagram of the general process used in the invention for the manufacture of alternative carbon black.

FIG. 2 is a flow diagram of the carbonization process.

FIG. 3 is a diagram of the general arrangement of plant components.

### DETAILED DESCRIPTION

The invention is related to the process of carbonizing waste tires and plastics together in order to produce an alternative carbon black product. In one embodiment this product could be used in the tire manufacturing industry which consumes approximately 80% of the carbon black currently produced by traditional methods. In another embodiment the product could be further processed to improve its quality for other manufacturing processes. This invention is ecologically friendly in that petroleum product consumption and carbon dioxide output is vastly reduced over traditional carbon black manufacture methods. Another positive aspect environmentally is in promoting the recycling of waste tires and plastics as these serve as the raw materials in the process. Traditional carbon black manufacturing uses various petroleum products as the raw input material and also produces a large output of waste carbon dioxide. One embodiment of the invention allows for the carbon black production facility to be located on the same premise as the tire manufacturing plant thus reducing expenses and environmental impacts of shipping the product from an offsite plant.

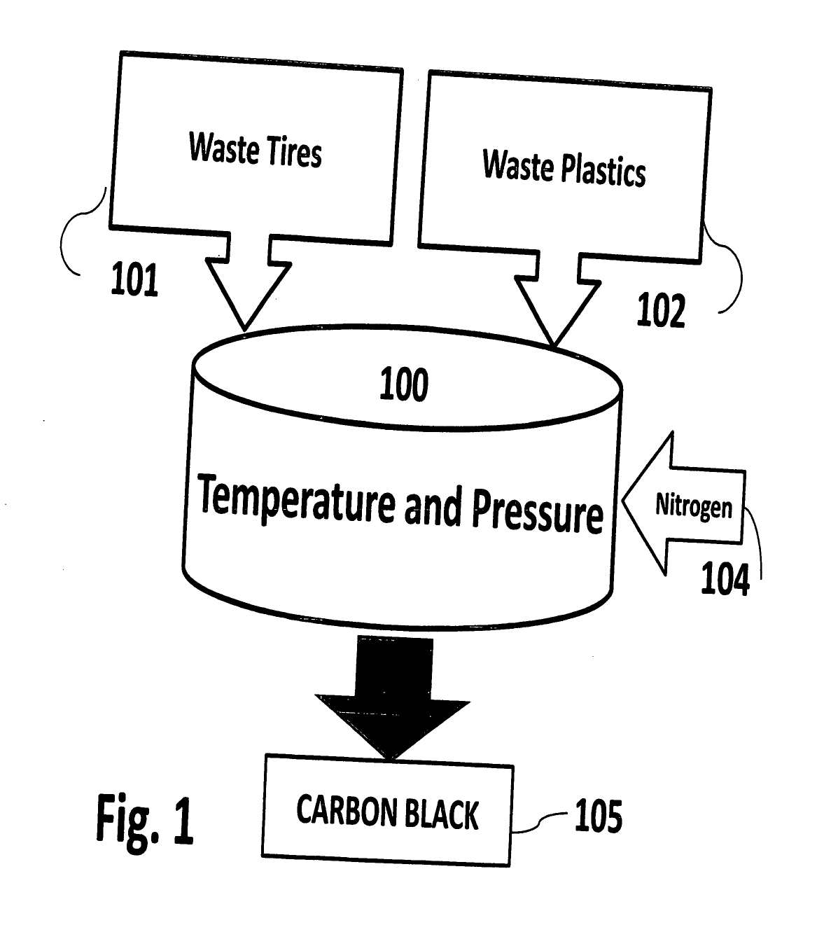

FIG. 1 is a diagram showing the general process for producing alternative carbon black in a preferred embodiment of the invention. Processed waste tires 101 and waste plastics 102 are the primary raw inputs to a specially designed reactor 100 capable of fine control of both temperature and pressure, and of the rates of change of both temperature and pressure. Because waste automobile tires and waste plastics are not biodegradable their disposal has become a significant environmental issue. This embodiment of the invention provides an economical way to solve this issue. A preferred embodiment utilizes waste PVC plastics as one raw input. PVC plastics are made up of approximately 57% chlorine and 39% carbon by weight. In other embodiments of the invention alternative high-halide content plastics may be used. Waste tires are approximately 83% carbon by weight. Other significant components in the tires are hydrogen, oxygen, sulfur and zinc. This material is mixed in a specific ratio and processed together in an inert atmosphere under a specific temperature and pressure range. The carbonization process is accomplished in the pressurized inert atmosphere within the reactor 100 with fine control of temperature and pressure and their rates of change. In an embodiment of the invention, nitrogen 104 is used to control the atmosphere in the reactor both by applying pressure and by preventing undesirable chemical reactions (especially oxidizing reactions) from taking place. In other embodiments alternative inert gases, such as argon, or mixtures of inert gases, can be used to prevent undesired reactions and to control pressure. The primary output product is carbon black in fine powder form 105.

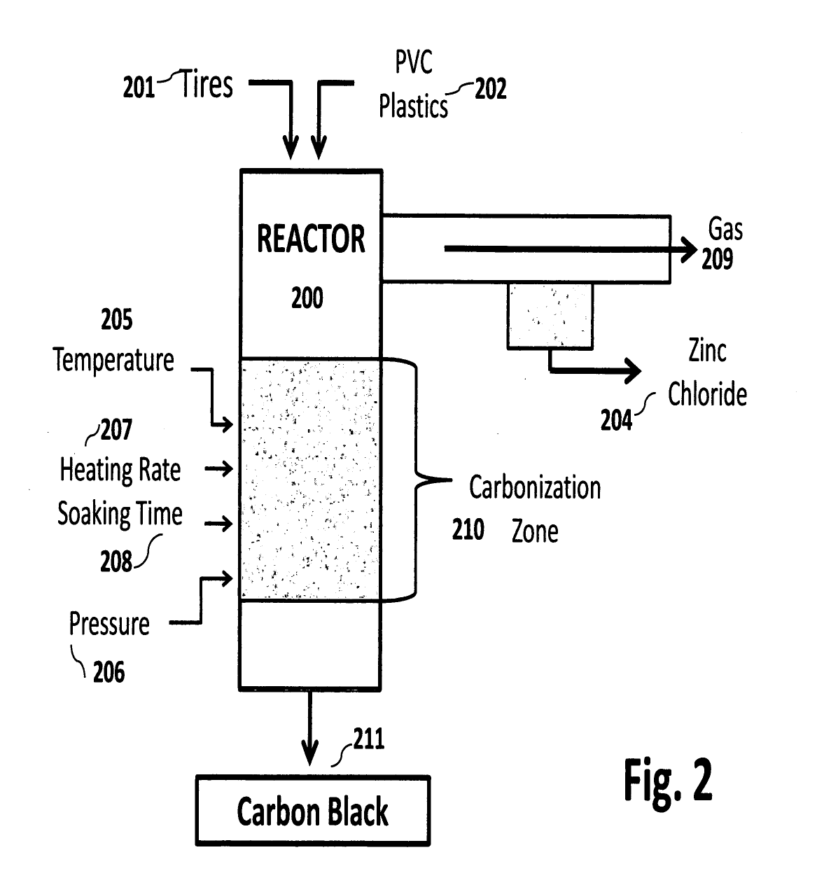

FIG. 2 is a simplified flow diagram of the carbonization process. Again the input raw materials in a preferred embodiment are waste tires 201 and waste plastics 202. In a preferred embodiment the plastic 202 is polyvinyl chloride plastic (PVC), but other plastics with high halide concentrations may also be used as input to the reaction. These are processed and mixed in a specific ratio. Tires contain approximately 2% zinc oxide and PVC plastics contain about 57% chlorine. In a preferred embodiment the carbon mass end product needs to be essentially free of zinc. The invention is based on the concept that by processing tires and PVC under certain pressure and temperature conditions, the zinc in the waste tires and the chlorine in the PVC react together to form zinc chloride 204 which can be removed from the final carbon product. An embodiment of the invention allows recovery of zinc chloride 204 from this process. In another embodiment the amount of zinc in the carbon black can be changed from approximately 60 ppm to 6000 ppm by varying the waste tire/PVC ratio (by mass) from about 100:12 to about 100:4.

The carbonization process is accomplished in an inert atmosphere within the pressurized reactor 200. Temperatures in the reactor 205 are controlled in a range from approximately 300 to 400 degrees C. Pressure 206 is also controlled and can range between approximately 100 psi and 300 psi. In an embodiment of the invention, the surface area and pore radius of the carbon black product can be varied by changing the operating temperature, pressure and rate of heating 207 within a specified range of approximately 20 deg. C./hr to 100 deg. C./hr. By changing the rate of heating the soaking time 208 is also altered. The process temperature 205 is a critical parameter affecting the carbon black end product 211. As the process temperature increases the following occur in the carbon black end product: particle size decreases; porosity increases; morphology changes from amorphous to more crystalline-like; weight loss increases; zinc in residue decreases; chorine in residue decreases. As the pressure increases the surface area of the solid residues decreases and the concentration of chlorine in the carbonized product is further reduced. The carbon black is formed within the carbonization zone 210 within the reactor by the incomplete combustion of the mixture of tires and plastics previously described. The final carbon black product 211 is in fine powder form and is generally ready to use in the production of tires. In a preferred embodiment of the invention the specific surface area of the carbon black product exceeds that of typical commercial carbon black making the final product of higher quality than traditionally produced carbon black. In one embodiment the product can be further processed to refine its quality to match the very best carbon based products available on the market

Another output of this process is the generation of high calorific value gases 209, which in another embodiment of the invention could be used as an energy source. Note that this process does not directly create pollutants such as carbon monoxide. The end products for this process make up to 80% carbon black 211, 15% hydrocarbon gases 209 and 5% zinc chloride 204. The zinc chloride is another recoverable end product in an embodiment of the invention.

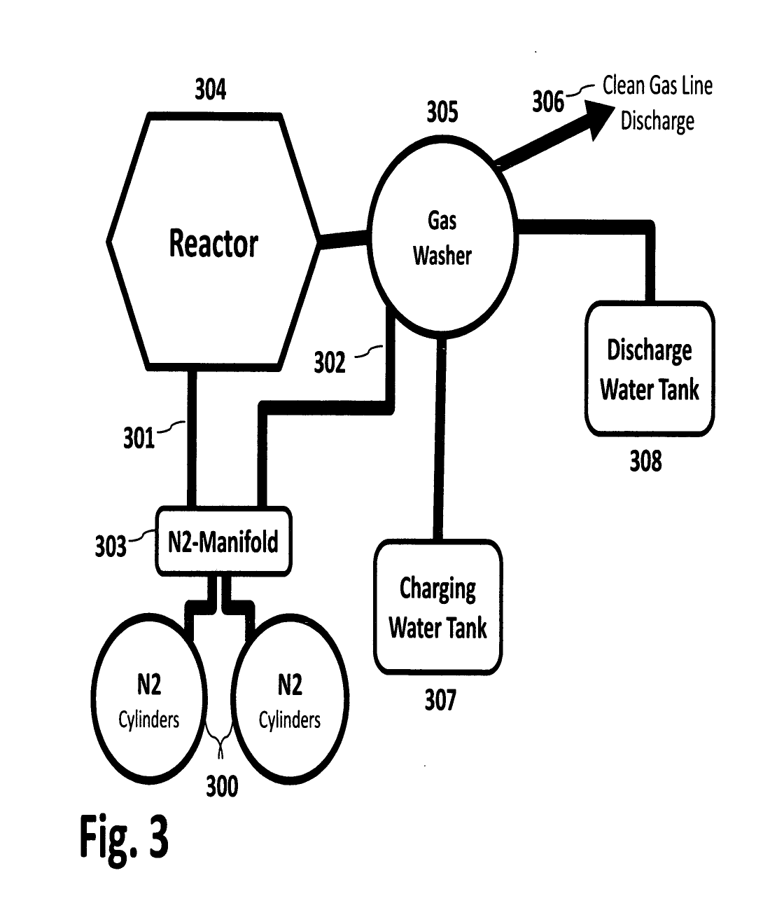

FIG. 3 is a flow diagram showing the general arrangement of a carbon black manufacturing plant using an embodiment of the invention. Compressed nitrogen cylinders 300 provide nitrogen for both pressurizing 301 the purging 302 the system. Nitrogen is distributed to the system by way of the nitrogen manifold 303. Pressurized nitrogen is piped 301 into the reactor 304 in order to displace air and create an inert environment with a pressure range of between 100 to 300 psi according to the specifications of an embodiment of the invention. Again, it should be appreciated that other inert gases or mixtures of gases can be used instead of nitrogen according to the invention. Reactor 304 is a pressure vessel and is provided with means for temperature control. In an embodiment of the invention, temperature control is provided by resistive electric heating elements, although it will be appreciated by one practiced in the art that there are many ways of applying heat to a pressure vessel at a controlled rate. Temperature sensors, such as thermocouples, are provided in preferred embodiments of the invention to measure temperature inside the reactor vessel 304. Gases produced by the partial combustion of the proprietary input waste product mix within the reactor are piped into a gas washer tank 305 where zinc chloride is removed. In an embodiment of the invention this zinc chloride is recoverable as a marketable byproduct. Clean gases can be discharged 306 or, in another embodiment of the invention, highly calorific gases are recycled to be used as an energy source. The gas produced from the process contains up to approximately 86% hydrocarbons. This gaseous mixture constitutes a very good fuel that in an embodiment of the invention could be recovered and used for example in the reheating furnace replacing natural gas or coke oven gas. The gas washing system is charged with water from the charging water tank 307. Discharged fluids are collected in the discharge water tank 308.

All of the embodiments outlined in this disclosure are exemplary in nature and should not be construed as limitations of the invention.

What is claimed is:

1. A method of manufacturing carbon black, comprising the steps of:
mixing waste tire material and waste plastic in a pressure vessel;
charging the pressure vessel with an inert gas to a desired pressure control range;
controllably heating the pressure vessel to increase temperature inside the vessel until the temperature reaches a desired temperature control range, while maintaining pressure within the pressure control range; and
maintaining temperature and pressure within the respective control ranges for a desired soak time while venting gases generated in the pressure vessel;
wherein substantially pure carbon black is produced.

2. A system for manufacturing carbon black, comprising:
a pressure vessel adapted for receiving waste tire material and waste plastics;
an inert gas charging system connected to the pressure vessel and capable of controllably applying pressure within the pressure vessel within a desired pressure control range;
means for controllably heating the pressure vessel to increase the temperature until the temperature reaches a desired temperature control range; and
means for venting gases generated by the reaction of the waste tire material and the waste plastics;
wherein the waste tire material and waste plastics react to generate carbon black.
